(19) United States
(12) Patent Application Publication
(10) Pub. No.: US 2008/0120915 A1
(43) Pub. Date: May 29, 2008

(54) Window assembly with rotatable pane

(76) Inventor: Oscar A. Flores, South Ozone Park, NY (US)

Correspondence Address: DILWORTH & BARRESE, LLP, 333 EARLE OVINGTON BLVD., SUITE 702, UNIONDALE, NY, 11553, US

(21) Appl. No.: 11/643,603

(22) Filed: Dec. 21, 2006

Related U.S. Application Data
(60) Provisional application No. 60/842,334, filed on Sep. 5, 2006.

(51) Int. Cl. E06B 3/50

(52) U.S. Cl. 49/501

(57) ABSTRACT

A window assembly includes a master frame, a sash mounted to the master frame and movable between an open position and a closed position, and a pane assembly pivotally mounted to the sash and rotatable 360° around an axis.

### CROSS REFERENCE TO RELATED APPLICATIONS

The present application claims priority to U.S. Provisional application Ser. No. 60/842,334 filed Sep. 5, 2006, which is herein incorporated by reference.

### BACKGROUND

1. Field of the Invention

The present invention relates to windows for building construction, particularly windows with pivoting components.

2. Background of the Art

Windows having pivoting components are known in the art. In particular, it is known to have a window with a pivotable sash which can be opened, for example, by a hand crank mechanism.

U.S. Pat. No. 4,337,597 to Struckmeyer discloses a sliding window construction that includes one or more panes slidable to open or close the window opening, each of the panes being pivotal in addition to being slidable to provide access to both sides of the window pane to facilitate cleaning of both sides of the glass pane from the inside of the room.

U.S. Pat. No. 4,860,811 to Flakk discloses a turnable window arrangement that has a window sash to be rotated about a horizontal axis through approximately 180° relative to a window frame. The window frame is provided with a separately removable air screening filter secured to the frame in a position inside the swinging path of said sash. A link arm mechanism is arranged to lock the sash in different positions between completely closed and opened venting positions.

U.S. Pat. No. 7,024,821 to Lu discloses a window that can be opened in multiple manners such as pushing/pulling and rotating outwards by using a sliding pipe assembly, includes a frame assembly and at least two sash assemblies. A horizontal frame in the frame assembly has a cavity with an opening, a guide track mounted on a bottom slab of the horizontal frame cavity, and a pair of subsidiary guide tracks provided on a pair of side slabs of the horizontal frame cavity. Several roller devices are arranged along the sliding pipe assembly and matched with the guide track and subsidiary guide tracks of the horizontal frame. Therefore, the sliding pipe assembly can be moved along the horizontal frame. Furthermore, a hinge assembly fastened to the sliding pipe assembly is provided in one of several stiles of each of the sash assemblies to be used for supporting rotation of the sash assemblies.

### SUMMARY

A window assembly is provided herein which comprises a master frame, a sash mounted to the master frame and movable between an open position and a closed position; and a pane assembly pivotally mounted to the sash and rotatable 360° around an axis.

### BRIEF DESCRIPTION OF THE DRAWINGS

Various embodiments are described below with reference to the drawings wherein:

FIG. 1 is an elevational view of the window assembly of the invention;

FIG. 2 is an elevational view illustrating the rotation of the pane assembly;

FIG. 3 is a plan view illustrating the rotation of the pane assembly;

FIG. 4 is a perspective view of the slide lock panel;

FIG. 5 is a partial perspective view of the window assembly;

FIG. 6 is a sectional view of a portion of the window assembly showing the slide lock panel in the engaged position;

FIG. 7 is a sectional view of a portion of the window assembly showing the slide lock panel in the disengaged position;

FIG. 8 is another sectional view of a portion of the window assembly;

FIG. 9 is an elevational sectional view of a portion of the window assembly illustrating the pivot pin;

FIG. 10 is a side elevational view of the window assembly taken along the lines 10-10 in FIG. 9;

FIG. 11 is a view of the window assembly taken along lines 11-11 in FIG. 9;

FIG. 12 is a view of the window assembly taken along lines 12-12 in FIG. 9;

FIG. 13 is an elevational view of a picture window embodiment of the invention;

FIG. 14 is an elevational view of a casement window embodiment of the invention;

FIG. 15 is a plan view illustrating the operation of the window assembly of the invention; and,

FIG. 16 is an elevational view of a double sash embodiment of the invention.

### DETAILED DESCRIPTION OF THE PREFERRED EMBODIMENTS

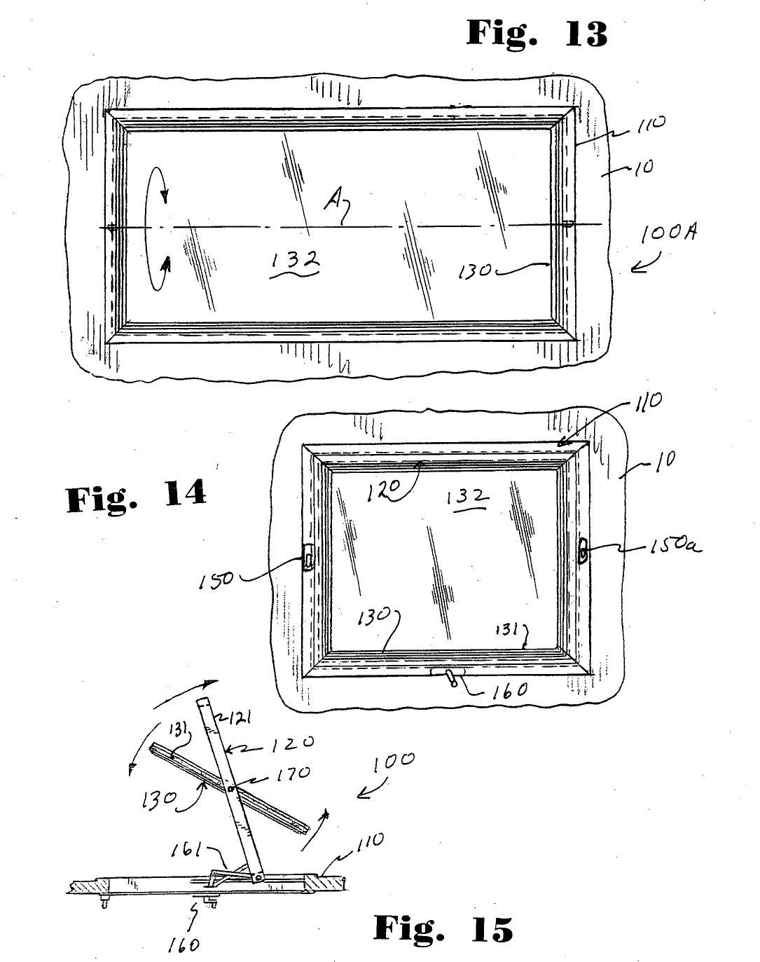

Referring to the drawings FIGS. 1, 14 and 15 the window assembly 100 of the invention includes a master frame 110 for installation in a wall 10 of a building. Master frame 110 can be fabricated from any conventional material such as wood, metal (e.g., aluminum, steel, etc.), plastic (e.g. polyvinylchloride (PVC)), and the like. In an embodiment of the invention sash 120 is pivotally mounted within master frame 110 and is movable between a closed position as shown in FIGS. 1 and 14 and an open position as shown in FIG. 15. Typically, the sash 120 is configured to open outwardly from the building. A conventional user-operated hand crank 160, connected by means of hinged links 161 to the sash frame 121 can be used for opening and closing the sash 120. Sash frame 121 can be made of any conventional construction material such as wood, metal, PVC and the like. One or more conventional latch 150 (optionally with additional latch 150a such as in the case of awning windows) can be used to lock the sash 120 in the closed position or release it for opening.

A feature of the invention includes a pane assembly 130 which is pivotally mounted within the sash frame 121 and is completely rotatable (i.e., 360°) clockwise or counterclockwise around an axis A defined by pivot pins 170. The axis A can be vertically oriented (FIG. 1) or horizontally oriented (FIG. 13). The complete rotatability of the pane assembly allows easy access to both sides of the window pane 132 from the interior of the building for easy cleaning.

The pane assembly 130 includes a border frame 131 in which a pane 132 is fixedly mounted. Border frame 131 can be fabricated of any conventional construction material such as wood, metal, PVC, etc. Pane 132 is typically a sheet of transparent or translucent, tinted or colorless material such as glass, or a synthetic polymeric material such as acrylic sheet, polycarbonate, and the like.

Referring also now to FIG. 9, border frame 131 is rotatably mounted by pivot pins 170 to the sash frame 121.

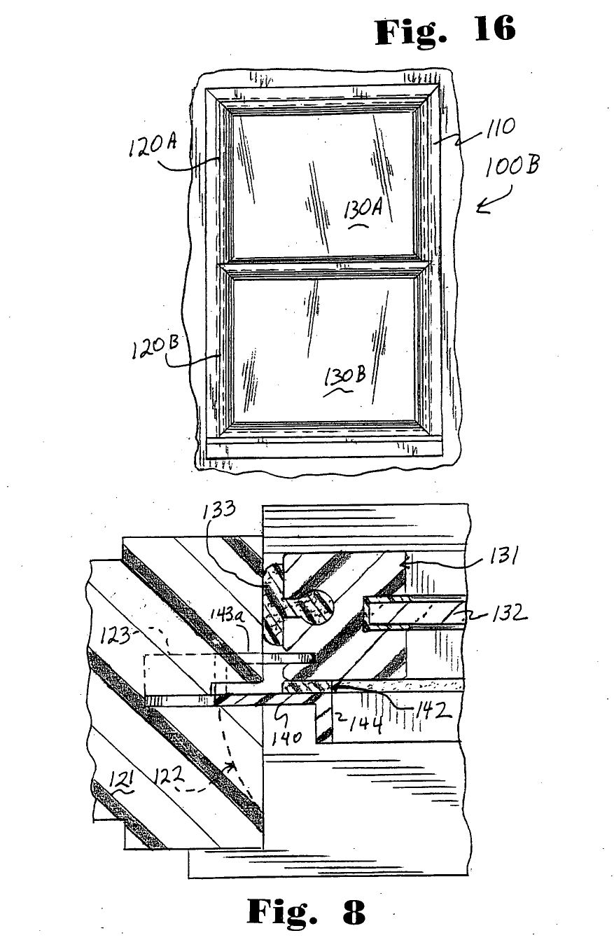

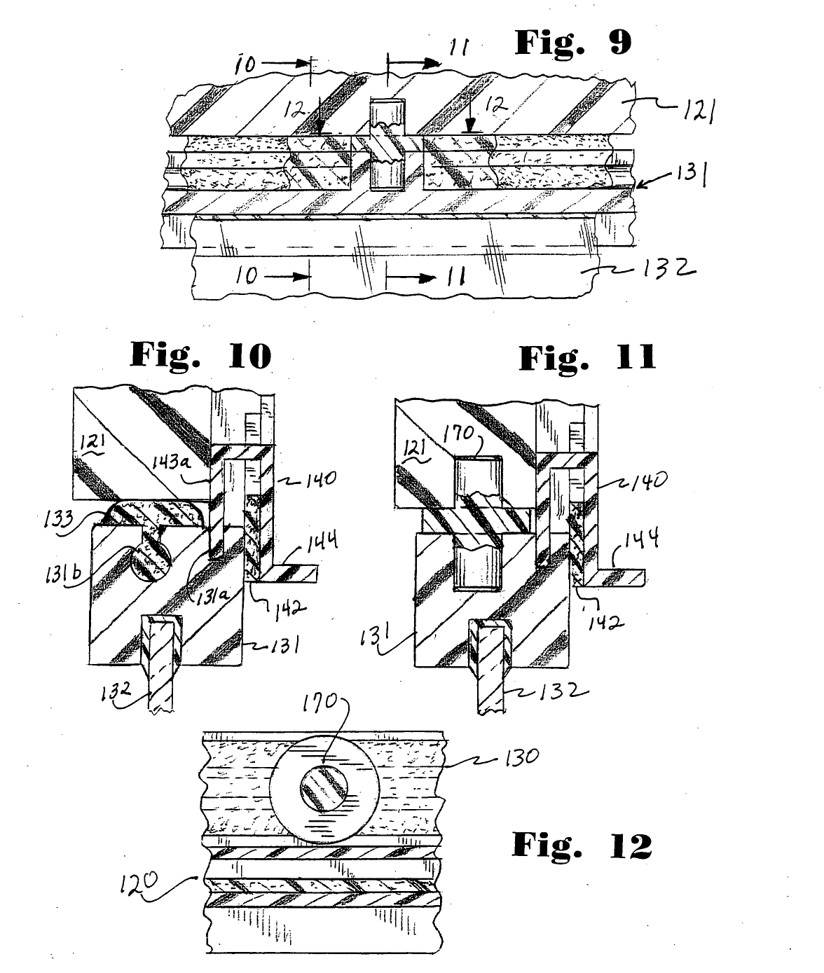

Referring now to FIGS. 6-9, border frame 131 includes a recess 131b in which a portion of weather stripping 133 is engaged. Weather stripping 133 can be fabricated from any material suitable for the purposes described herein, such as synthetic polymer which is flexible and resilient so as to form a weather tight seal between the border frame 121 and the interior edge of sash frame 131 when the pane assembly 130 is in a closed position.

Another feature of the invention of the invention includes means for locking the pane assembly 130 in a closed position with respect to the sash 120. In one embodiment, a suitable locking mechanism includes one or more locking panels 140 which are slidably mounted within corresponding slots 123 in the sash frame 121. Locking panels 140 prevent unauthorized rotation of the pane assembly 130 from outside of the building. That is, when actuated, slidable locking panels 140 secure the pane assembly 130 to the sash 120 in a closed position. The sash 120 can be secured in a closed position to the master frame 110 by latch 150 (and optionally additional latch 150a). Double locking in this manner prevents unauthorized access through the window assembly 100 to the interior of the building from outside.

Locking panels 140 each include an elongated strip 141 having a transverse projecting ridge 144, and at least one (and optionally 2 or more) L-shaped detents 143, each having a tongue portion 143a adapted to engage a corresponding notch 131a in the border frame 131 of the pane assembly 130. Recesses 122 in the sash frame 121 facilitate grasping by a user's finger of the ridge 144 in the locking panel so as to slide the locking panel 140 into engagement with the pane assembly. Locking panels 140 further include a weather strip 142 to serve as an insulative seal against the weather, dust, insects, etc. Weather strip 142 can be a resilient, polymeric material, felt or any other material suitable for the purposes described herein. Locking panels 140 can be installed on each of the four sides of the sash frame so as to both securely lock the pane assembly 130 and provide an additional seal against the weather or other external environmental conditions. To facilitate the use of multiple locking panels 140, each locking panel can include angled corner edges 145 which abut the corresponding angled corner edges of the adjacent locking panels when in the locking position.

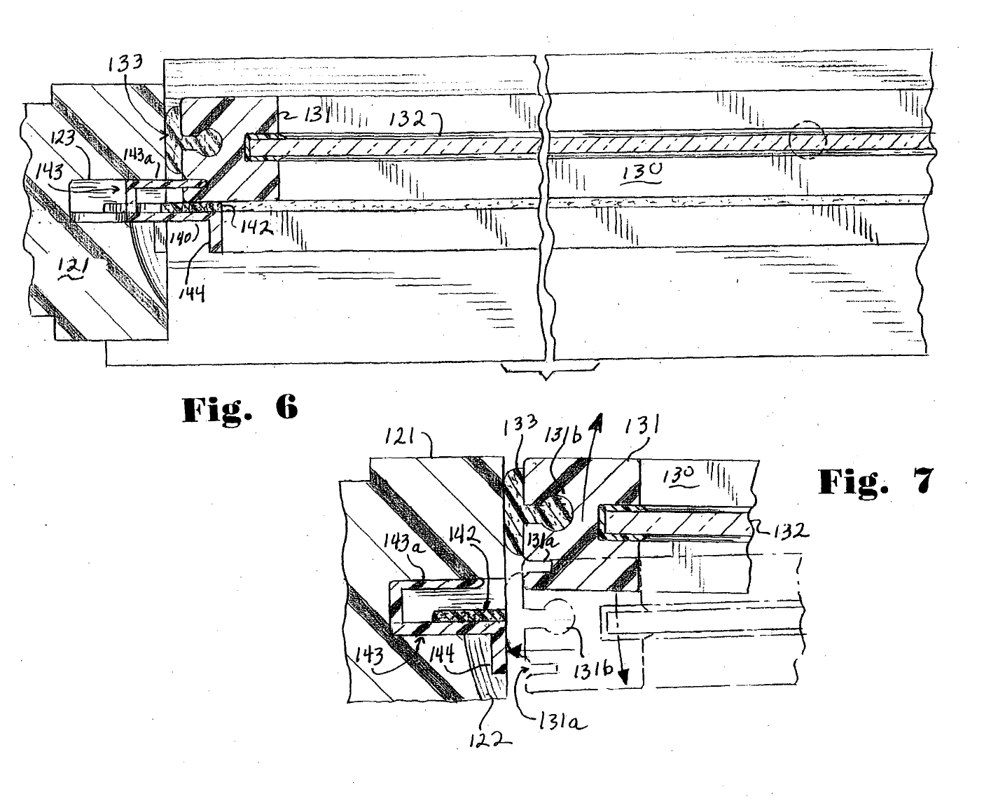

Referring particularly now the FIGS. 6 and 7, locking panel 140 is shown in a locking position (FIG. 6) wherein tongue portion 143a is engaged in slot 131a to hold the pane assembly in a closed position. FIG. 7 shows the locking panel 140 moved within slot 123 in the sash frame so as to be disengaged from the pane assembly 130, thereby allowing the pane assembly 130 to be rotated with respect to the sash 120.

Alternative locking mechanisms can be used. For example, a sliding bolt can be mounted to the border frame 131 or the sash frame 121 with a corresponding receptacle or recess on the other of the sash frame or border frame. However, the slidable locking panels 140 of the invention provide both a locking feature and a seal against outside environmental conditions.

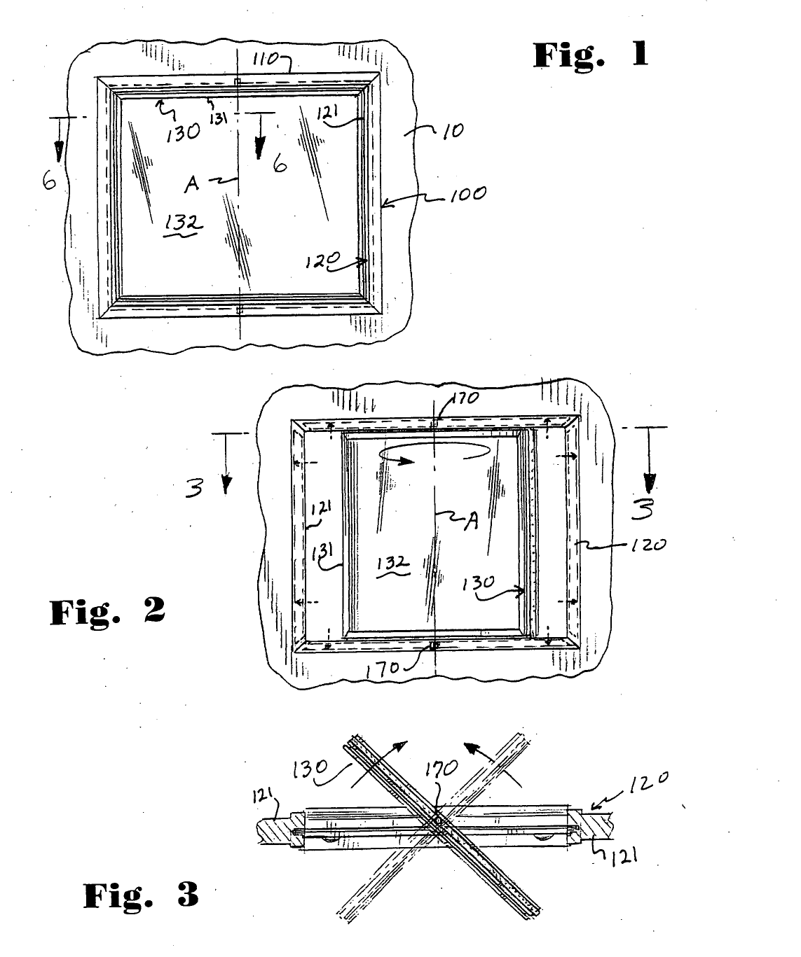

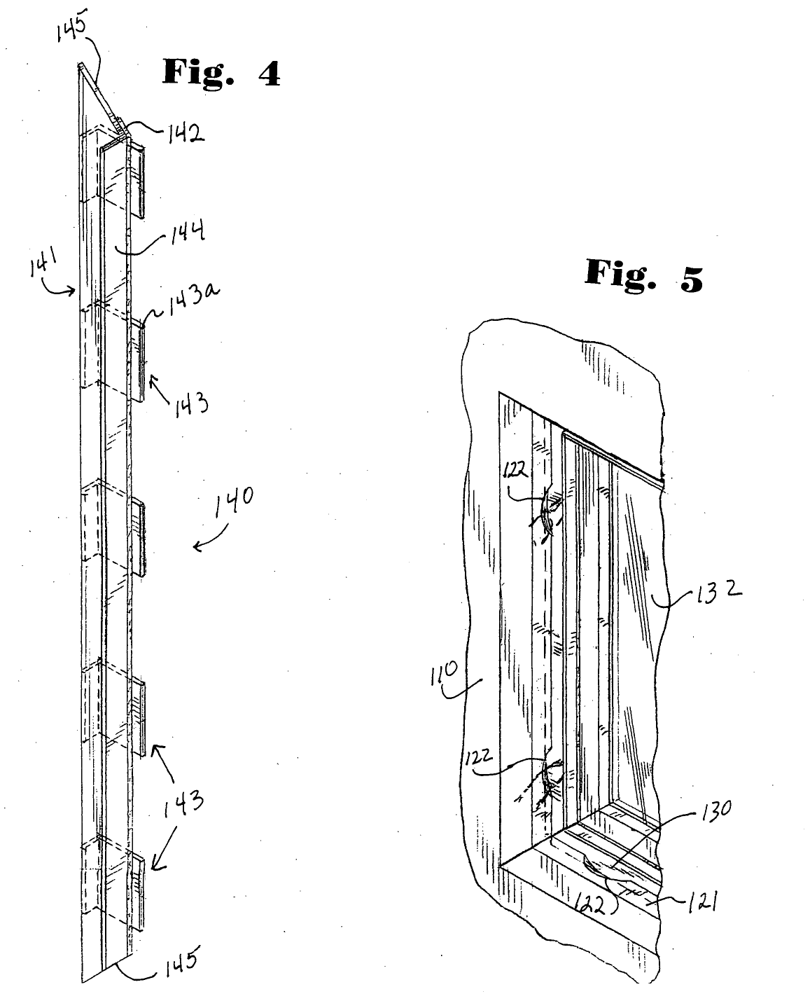

Pivot pins 170 can be oriented horizontally so as to define a horizontal axis A around which the pane assembly 130 rotates as shown in FIG. 13 to facilitate the operation of a picture window embodiment 100A of the invention. Alternatively, pivot pins 170 can be oriented vertically so as to define a vertical axis A around which the pane assembly 130 rotates as shown in FIGS. 2 and 3.

The window assembly 100 of the invention can be used in conjunction with casement windows (FIGS. 1-3, 16), picture window 100A (FIG. 13), or multiple sash windows such as double hung window 100B (FIG. 16). In the picture window embodiment 100A (FIG. 13) the 360° rotatable pane assembly can optionally be pivotally connected directly to the master frame 110 without the necessity of a separate sash.

Referring particularly now to FIG. 16, preferably two sashes 120A and 120B are slidably rather than pivotally mounted within master frame 210 of double hung window 200. The sashes 120A and 120B can be vertically slidable within master frame 110, as shown in FIG. 16, or can alternatively be horizontally slidable such as in the case of sliding windows and patio doors. The sashes 120A and 120B each include a rotatable pane assembly 130 and locking panels 140 as described above. However, double hung window 200 does not employ a hand crank 160. A conventional locking mechanism can be used to prevent relative sliding movement of the sashes 120A and 120B.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A window assembly comprising
a) a master frame;
b) at least one sash mounted to the master frame and relatively moveable with respect to the master frame between an open position and a closed position; and
c) a pane assembly pivotally connected to the sash and rotatably movable 360° around an axis.

2. The window assembly of claim 1 wherein the at least one sash is hingedly mounted to the master frame and pivotably movable with respect thereto.

3. The window assembly of claim 1 wherein the at least one sash is slidably mounted to the master frame and linearly movable with respect thereto.

4. The window assembly of claim 1 wherein the axis is vertical.

5. The window assembly of claim 1 wherein the axis is horizontal.

6. The window assembly of claim 1 wherein the sash comprises a sash frame.

7. The window assembly of claim 6 wherein the pane assembly comprises a border frame and a transparent or translucent pane mounted to the border frame.

8. The window assembly of claim 7 further including a means for locking the pane assembly in a closed position.

9. The window assembly of claim 8 wherein the means for locking the pane assembly comprises at least one locking panel slidably mounted to the sash frame and movable between an unlocked position and a locking position and engageable with the border frame when moved into the locking position.

10. The window assembly of claim 9 wherein the locking panel includes at least one L-shaped detent with a tongue portion for engagement with a corresponding notch in the border frame.

11. The window assembly of claim 9 wherein the means for locking the pane assembly comprises at least one locking panel for each side edge of the sash frame, each locking panel having an angled edge for abutting a matching angled edge of an adjacent locking panel when the locking panels are moved into the locking position.

12. The window assembly of claim 9 wherein the at least one locking panel is slidably mounted within a corresponding slot in the sash frame.

13. The window assembly of claim 9 wherein the window assembly includes a weather strip for sealing the window assembly with respect to environmental conditions.

14. The window assembly of claim 7 wherein the pane assembly comprises a weather seal strip disposed along an exterior edge surface of the border frame and engageable with an interior edge surface of the sash frame when the pane assembly is in a closed position for sealing the window assembly with respect to environmental conditions.

15. The window assembly of claim 14 wherein the weather seal strip is fabricated from a resilient polymeric material.

16. The window assembly of claim 1 wherein the window assembly is a casement window, a double hung window or a picture window.

17. The window assembly of claim 1 including at least two sashes slidably mounted to the master frame.

18. The window assembly of claim 11 wherein the at least two sashes are vertically slidable with respect to the master frame.

19. The window assembly of claim 11 wherein the at least two sashes are horizontally slidable with respect to the master frame.

20. A picture window comprising:
a) a master frame; and
b) a pane assembly pivotally connected to the master frame and rotatable 360° around an axis.
